(19) United States
(12) Patent Application Publication
(10) Pub. No.: US 2008/0129827 A1
(43) Pub. Date: Jun. 5, 2008

(54) ELECTRONIC CAMERA AND CONTROL METHOD THEREOF

(75) Inventor: Takashi Morino, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/857,950

(22) Filed: Sep. 19, 2007

(30) Foreign Application Priority Data
Dec. 1, 2006 (JP) 2006-325667

(51) Int. Cl. H04N 5/235; H04N 5/335; H04N 5/228

(52) U.S. Cl. 348/207.1; 348/222.1; 348/372

(57) ABSTRACT

An electronic camera is provided which can transfer shot data to an external device. The electronic camera includes an operation unit configured to instruct a shooting preparation operation or a shooting operation, a connection unit configured to establish a logical connection with an external device, and a control unit configured to perform control so that the connection unit establishes a logical connection with the external device when the shooting preparation operation or the shooting operation is started by the operation unit.

### BACKGROUND OF THE INVENTION

1. Field of the Invention

The present invention relates to an electronic camera, which can transfer shot data to an external device.

2. Description of the Related Art

In recent years, digital cameras, which digitalize an optical image of an object and store the digitalized image have become commercially practical. Such digital cameras can record the shot data on a detachable recording medium. Further, as discussed in Japanese Patent No. 03190651, cameras that are provided with an interface for external connection such as a universal serial bus (USB), an IEEE1394, or a local area network (LAN), can transfer the shot data to an external device connected to them, for example, a personal computer.

Further, there are various types of detachable recording media as described above. For example, there are recording media that are incorporated as internal mechanisms and performs rotation operation such as a Microdrive® or a hard disk. In such recording media, after a recording instruction is issued, the rotation is started, and when the rotation speed reaches a predetermined speed, the data is actually written on them.

Before the data is transferred to an external device, a logical connection has to be established in advance according to a procedure defined according to various connection interfaces. If the device is in the logical connection state, the data can always be transferred to the external device. To establish the logical connection, it takes time, for example, several seconds to several tens of seconds in a case of long time.

As described above, to perform recording on a recording medium which performs the rotation operation, it takes more time for the initialization operation as compared to the other recording media. Further, since the rotation operation consumes larger power, it is disadvantageous from a standpoint of power consumption if the recording medium is always rotated.

Further, in order to transfer the data to the external device at a high speed, it is necessary to set the devices in the logical connection state. However, it is inefficient to always keep the logical connection state because it also increases power consumption. Therefore, there are cases where a part of the power supply to the external device is stopped, that is, the mode of the device enters into a so-called power-saving mode, or all the power supply to the external device is stopped. In such a case, to start recording or a transfer next time, the logical connection has to be established again. Thus, the transfer efficiency is decreased due to the connection time, and it becomes a serious drawback in a system that requires transfer efficiency at a high-speed.

### SUMMARY OF THE INVENTION

According to an aspect of the present invention, an electronic camera which can transfer shot data to an external device includes an operation unit configured to instruct a shooting preparation operation or a shooting operation, a connection unit configured to establish a logical connection with an external device, and a control unit configured to perform control so that the connection unit establishes a logical connection with the external device by when the shooting preparation operation or the shooting operation is started by the operation unit.

Further features and aspects of the present invention will become apparent from the following detailed description of an exemplary embodiment with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a view illustrating an example configuration of an electronic camera according to an exemplary embodiment of the present invention.

FIG. 2 is a flowchart illustrating an example shooting sequence according to the exemplary embodiment of the present invention.

FIG. 3 is a flowchart illustrating an example preparation sequence for recording data in a recording medium in the shooting sequence according to the exemplary embodiment of the present invention.

FIG. 4 is a flowchart illustrating an example preparation sequence for transferring data to an external device in the shooting sequence according to the exemplary embodiment of the present invention.

### DETAILED DESCRIPTION OF THE EXEMPLARY EMBODIMENTS

Various exemplary embodiments, features, and aspects of the invention will be described in detail below with reference to the drawings.

### First Exemplary Embodiment

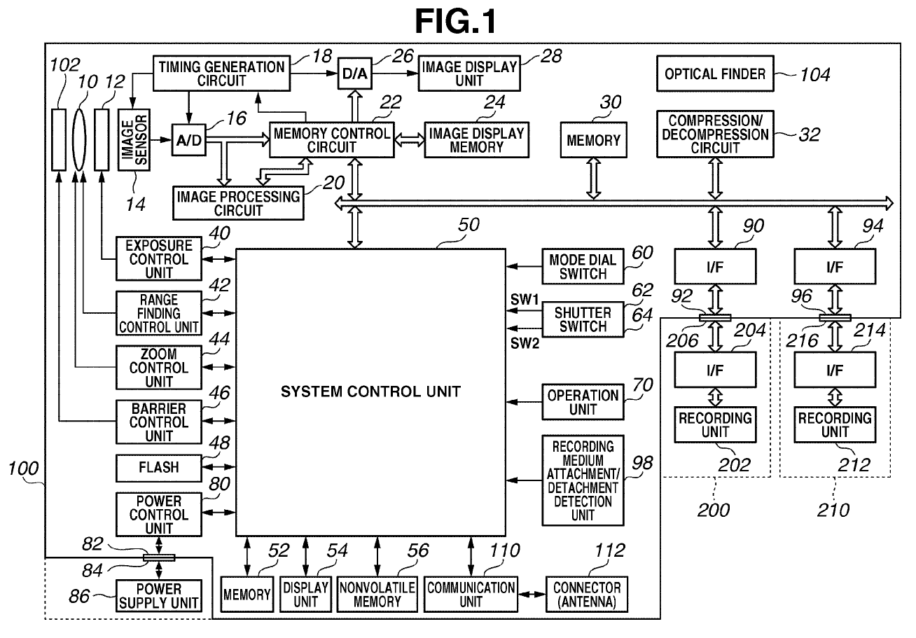

FIG. 1 is a view illustrating an example configuration of an electronic camera according to the first exemplary embodiment of the present invention. An electronic camera 100 can transfer shot data to an external device. Reference numeral 10 denotes a photographic lens, and reference numeral 12 denotes a shutter which has a diaphragm function. An image sensor 14 converts an optical image into an electric signal, and an A/D converter 16 converts an analog signal of the image sensor 14 into a digital signal.

A timing generation circuit 18 supplies a clock signal or a control signal to the image sensor 14, the A/D converter 16, and a D/A converter 26. The timing generation circuit 18 is controlled by a memory control circuit 22 and a system control circuit 50.

An image processing circuit 20 performs predetermined pixel interpolation processing or color conversion processing on data sent from the A/D converter 16 or from the memory control circuit 22. The image processing circuit 20 also performs a predetermined arithmetical operation using shot image data. Based on an arithmetic result obtained in the image processing circuit 20, the system control circuit 50 performs processing to control an exposure control unit 40 and a range finding control unit 42, that is, auto focus (AF) processing, auto exposure (AE) processing, and automatic brightness control processing by electronic flash (EF) pre-emission according to a through the lens (TTL) system. Further, using the shot image data, the image processing circuit 20 also performs a predetermined arithmetical operation, and performs auto white balance (AWB) processing according to the TTL system based on the arithmetic result.

The memory control circuit 22 controls the A/D converter 16, the timing generation circuit 18, the image processing circuit 20, an image display memory 24, the D/A converter 26, a memory 30, and a compression/decompression circuit 32. Image data output from the A/D converter 16 is written in the image display memory 24 or the memory 30 through the image processing circuit 20 and the memory control circuit 22, or directly through the memory control circuit 22.

An image display unit 28 is formed by a thin film transistor-liquid crystal display (TFT-LCD). The display image data written in the image display memory 24 is displayed by the image display unit 28 through the A/D converter 26. By sequentially displaying the shot image data on the image display unit 28, an electronic finder function can be realized. The image display unit 28 can turn on or off the display in response to an instruction from the system control circuit 50. When the display is turned off, the power consumption of the image sensing apparatus 100 can be significantly reduced.

The detachable memory 30 stores a captured still image or a captured moving image, and whose capacity is large enough to store a predetermined sheets of still images or the moving images captured in a predetermined time period. Thus, in a continuous shooting of a plurality of still images or panoramic shooting, a large amount of images can be written in the memory 30 at a high speed. The memory 30 can also be used as a work area of the system control circuit 50.

The compression/decompression circuit 32 compresses or decompresses image data with an adaptive discrete cosine transform (ADCT) and the like. The compression/decompression circuit 32 can read image data stored in the memory 30, compress or decompress the data, and write the processed image data in the memory 30.

The exposure control unit 40 controls the shutter 12 which has a diaphragm function, and in cooperation with a flash 48, also performs a flash brightness control function. The range finding control unit 42 controls focusing of the photographic lens 10. A zoom control unit 44 controls zooming of the photographic lens 10. A barrier control unit 46 controls an operation of a protection unit 102 which functions as a barrier.

The flash 48 also has a function of projecting an AF auxiliary light and a function of flash light amount control. The exposure control unit 40 and the range finding control unit 42 are controlled according to the TTL system. The system control circuit 50 controls the exposure control unit 40 and the range finding control unit 42 based on a calculation result obtained by calculating the shot image data with the image processing circuit 20.

The system control circuit 50 controls the entire image processing apparatus 100. A memory 52 stores constants, variables, and programs used in the operations of the system control circuit 50.

A liquid crystal display device 54 functions as a display unit which displays an operation state or a message using characters, images, or sound in response to an execution of a program in the system control circuit 50. Single or a plurality of the display units is arranged at appropriate positions where users can readily view the displays, in the vicinity of the operation unit of the image sensing apparatus 100. The display unit 54 includes, for example, a combination of a liquid crystal display (LCD), a light emitting diode (LED), or a sound element. A part of functions of the display unit 54 is placed within an optical finder 104.

From among contents displayed by the display unit 54, ones displayed on an LCD are a single shot/continuous shooting mode indication, a self timer indication, a compression ratio indication, the number of recording pixels, the number of recorded images, the remaining number of recordable images, a shutter speed indication, an aperture value indication, and an exposure compensation indication. Further, a flash indication, a red-eye reduction indication, a macro shooting indication, a buzzer setting indication, a remaining amount of a battery for a timer, a remaining amount of a battery, an error indication, information using a plurality of digits, attached state of a recording medium 200 or 210, operation of a communication I/F, and date/time are displayed on the LCD.

On the other hand, the contents displayed in the optical finder 104 are an in-focus indication, a camera-shake warning indication, a flash charge indication, a shutter speed indication, an aperture value indication, an exposure compensation indication, and the like.

A nonvolatile memory 56 is an electrically erasable/recordable memory such as an electronically erasable and programmable read only memory (EEPROM).

An operation unit includes components shown by reference numerals 60, 62, 64, and 70, and is used to input various operation instructions of the system control circuit 50. The operation unit is composed of a single component or a combination of, for example, a switch, a dial, a touch panel, a pointing by visual line detection, and a voice recognition device.

Now, the operation unit will be described in detail. A mode dial switch 60 can switch among various functional modes such as a power-off, an automatic shooting mode, a shooting mode, a panoramic shooting mode, a playback mode, a multiwindow playback/erase mode, and a PC connection mode.

A shutter switch SW1 62 is turned on halfway during the operation of a shutter button (not illustrated), and instructs to start shooting preparation which is to be performed before a shooting, for example, AF processing, AE processing, AWB processing, and EF processing.

A shutter switch SW2 64 is turned on when the shutter button (not illustrated) is further strongly pressed than the SW1 62 and instructs to start a shooting operation. In response to the turning-on, an exposure processing is performed. In the exposure processing, a signal read from the image sensor 14 is written in the memory 30 through the A/D converter 16 and the memory control circuit 22. Subsequently, a start of a series of operations is instructed, which include an image forming by using the calculation result obtained in the image processing circuit 20 or the memory control circuit 22, reading out the image data from the memory 30, compressing the data in the compression/decompression circuit 32, and writing the data in the recording medium 200 or 210.

The operation unit 70 includes various buttons or a touch panel, for example, a menu button, a set button, a macro button, a page break button for multiwindow playback, a flash setting button, and a single shooting/continuous shooting/self timer switching button. The operation unit 70 can also include a menu movement + (plus) button, a menu movement − (minus) button, a playback image movement + (plus) button, a playback image movement − (minus) button, a shot image quality selection button, an exposure correction button, and a date/time setting button.

A power control unit 80 includes a battery detection circuit, a DC/DC converter, and a switch circuit which selects a block to be energized. The power control unit 80 detects a presence/absence of a battery, a battery type, and a remaining amount of a battery. The power control unit 80 controls the DC/DC converter based on the detection result and an instruction from the system control circuit 50, and supplies a necessary voltage to each block including a recording medium for a necessary period.

Reference numerals 82 and 84 denote connectors, and a power supply unit 86 includes a primary cell such as an alkaline cell or a lithium cell, a secondary cell such as a NiCd cell, a NiMH cell, or Li cell, and an AC adapter.

Interfaces 90 and 94 perform interface with recording media such as a memory card or a hard disk. Connectors 92 and 96 make connection with the recording media such as a memory card or a hard disk. A recording medium attachment/detachment detection unit 98 detects whether the recording medium 200 or 210 is connected to the connector 92 or 96.

In this exemplary embodiment, two systems of interfaces and connectors for attaching the recording media are provided. However, either single system or plural systems of the interfaces and connectors can be provided. Further, a combination of an interface and a connector of different standards can be used. In this regard, interfaces and connectors based on a standard such as a personal computer memory card international association (PCMCIA) card or CF (CompactFlash®) card can be used.

If interfaces and connectors based on the PCMCIA card or the CF (CompactFlash®) card are used as the interfaces 90 and 94 and the connectors 92 and 96, by connecting various communication cards, image data or management information associated with the image data can be transferred to/from another computer or a peripheral device. As the communication cards, a LAN card, a modem card, a USB card, an IEEE1394 card, a P1284 card, a small computer system interface (SCSI) card, or a communication card for personal handyphone system (PHS) can be used.

The protection unit 102 functions as a barrier to cover the shooting unit including the imaging lens 10 of the image processing apparatus 100 to prevent stain or damage to the shooting unit.

Shooting can be performed by using only the optical finder 104 without using the electronic finder function performed by the image display unit 28. In the optical finder 104, a part of functions of the display unit 54, for example, an in-focus indication, a camera-shake warning indication, a flash charge indication, a shutter speed indication, an aperture value indication, and an exposure compensation indication can be arranged.

A communication unit 110 can transfer image data or management information associated with the image data to/from another computer or an external device using various communication units such as an RS232C, a USB, an IEEE1394, a P1284, an SCSI, a modem, a LAN, or wireless communication.

A connector 112 is used to connect the image processing apparatus 100 to an external device using the communication unit 110. The connector 112 is an antenna in case of wireless communication. In the exemplary embodiment, it is assumed that an external recording device which directly communicates with the electronic camera is used as the external device and image data obtained by a shooting is smoothly transferred after the shooting is finished.

The recording medium 200 can be a memory card or a hard disk. The recording medium 200 includes a recording unit 202 which has a semiconductor memory, a magnetic disk, or the like, an interface 204 with the image processing apparatus 100, and a connector 206 which makes connection with the image processing apparatus 100.

The recording medium 210 can be a memory card or a hard disk. The recording medium 210 includes a recording unit 212 which has a semiconductor memory, a magnetic disk, or the like, an interface 214 with the image processing apparatus 100, and a connector 216 which makes connection with the image processing apparatus 100.

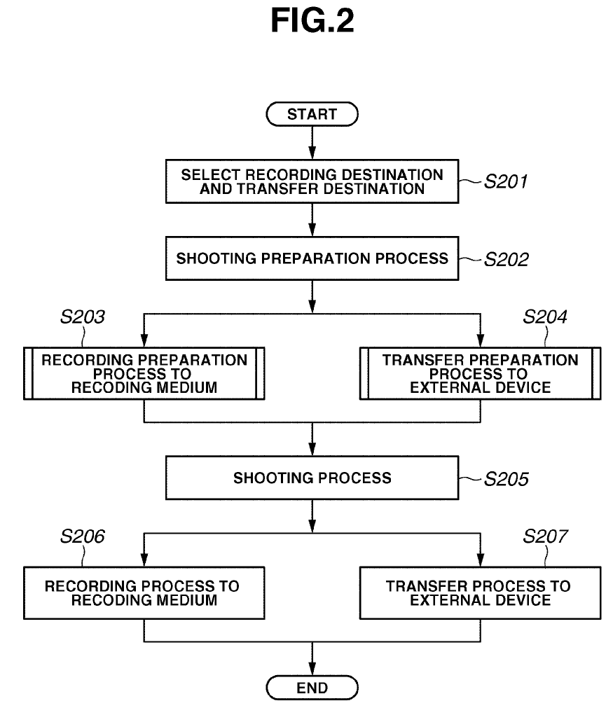

FIG. 2 is a flowchart illustrating a series of sequences from a shooting preparation to recording and transfer of an image data file. In step S201, using the operation unit 70 which includes the various buttons or a touch panel, a recording destination and a transfer destination of an image data file are selected. A memory of the recording destination (the memory 200 or 210) and a transfer destination (an external device coupled through the connector 112 and the communication unit 110) which are selected, are stored in the memory 30 or the nonvolatile memory 56.

In step S202, as previously mentioned in reference to FIG. 1, in response to the operation of the SW1 62 which forms a release switch (not shown), a series of shooting preparation to be performed before an operation start is carried out such as AF processing, AE processing, AWB processing, and EF processing

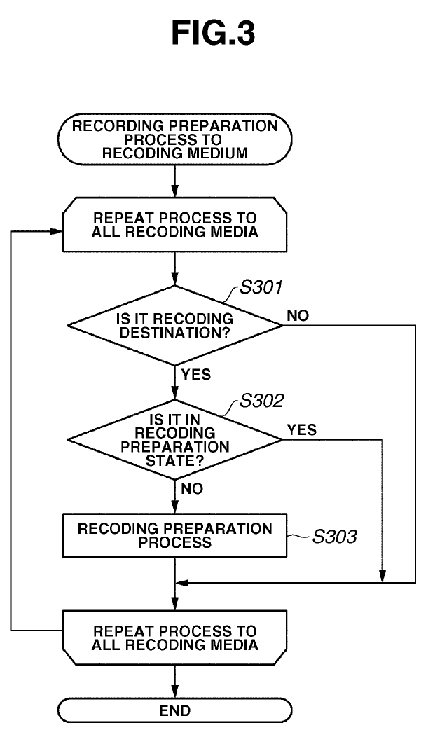

The branch to step S203 or step S204 is determined according to the selection in step S201. In step S203, an instruction to perform a preparation for recording the data in the recording medium is issued. With respect to the preparation for recording the data in the recording medium, detailed description will be made below with reference to FIG. 3.

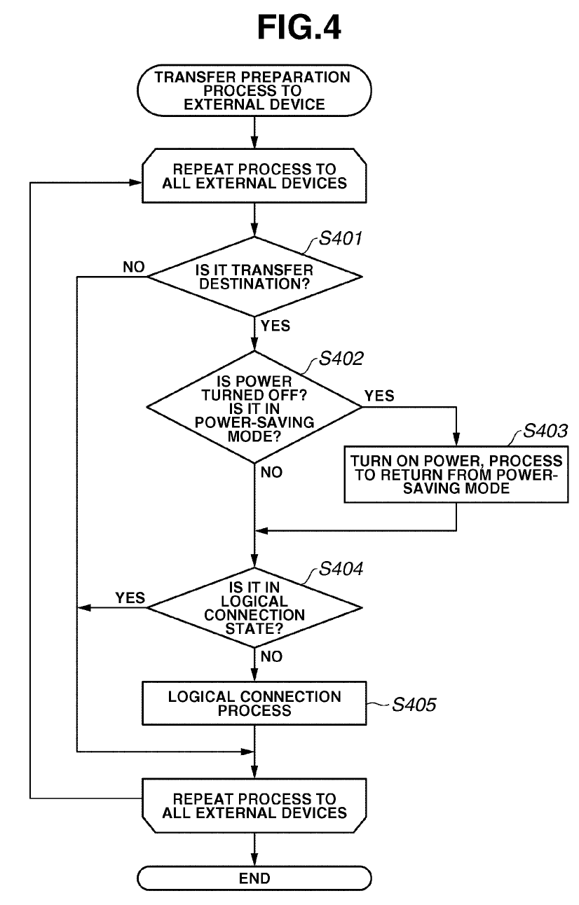

In step S204, an instruction to perform a preparation for transferring the data to the external device is issued. With respect to the preparation for transferring the data to the external device, detailed description will be made below with reference to FIG. 4.

In step S205, as described in the description of FIG. 1, in response to the operation of the SW2 64 which forms a release switch (not illustrated), a series of processing such as exposure processing, development processing, and compression processing are performed on a signal read from the image sensor 14. The processed signal is temporarily stored in the memory 30 as an image data file.

A branch to step S206 or step S207 is determined according to the selection in step S201. In step S206, the image data file temporarily stored in the memory 30 in step S205 is written in the recording destination stored in step S201. In step S207, the image data file temporarily stored in the memory 30 in step S205 is transferred to the transfer destination stored in step S201.

In the exemplary embodiment, for simplicity, the description has been made in order from step S201 to S207. However, for example, in the shooting processing of step S205, as in a case of the continuous shooting, a plurality of shooting can be performed and then, the recording processing of the next step S206 or the transfer processing of step S207 can be performed.

FIG. 3 is a flowchart illustrating a series of sequences for performing a preparation for recording data in a recording medium. The recording preparation is performed to enable a recording medium to record data. For example, the recording preparation includes processing for causing a recording medium on a disk to enter a constant rotation state from a stopped state. The recording preparation includes also processing for starting power supply to a control unit which performs recording control on the recording medium. That is, the recording preparation is performed to implement at least a part of processing before starting the recording of data, to enable an immediate recording processing of the data. It is noted that the above-described processing of step S301 to step S303 are performed to all recording media.

In step S301, with reference to the settings selected and stored in step S201 of FIG. 2, it is determined whether the recording medium (the recording medium 200 or 210) of the electronic camera is selected as the recording destination of the shot data. If it is determined that the recording medium is selected (YES in step S301), the process proceeds to step S302. If a plurality of recording media is connected to the electronic camera, first, any one of the recording media is selected, and then, the process proceeds to step S302.

In step S302, it is determined whether the recording medium is in a recording preparation state. If it is determined that the recording medium is not in the recording preparation state (NO in step S302), the process proceeds to step S303. Whether the recording medium is in the recording preparation state can be determined, for example, by checking whether a predetermined period has passed since the last access to the recording medium.

In step S303, an instruction for performing a recording preparation is issued to the recording medium. Then, in response to the instruction, the electronic camera continuously instructs the recording medium to perform the recording preparation until the image data file to be recorded is completely processed even if the recording preparation state ends after a predetermined period has passed.

FIG. 4 is a flowchart illustrating a series of sequences for performing a preparation for transferring data to an external device. If there is a plurality of external devices to communicate with, any one of the devices is selected and processing described below are repeatedly performed.

In step S401, with reference to the transfer destination selected and stored in step S201 of FIG. 2, it is determined whether the external device connected through the connector 112 and the communication unit 110 is selected as the transfer destination of the shot data. If it is determined that the external device is selected (YES in step S401), the process proceeds to step S402.

In step S402, it is determined whether power is supplied to the external device, or the external device is in a power-saving mode. If it is determined that the external device is in the power-off mode, or in the power-saving mode (YES in step S402), the process proceeds to step S403.

In step S403, if the external device is in the power-off mode, the power supply is restarted, and if the external device is in the power-saving mode, returning processing back to a normal mode is performed. In the returning processing back to the normal mode, a wakeup signal is transmitted from the electronic camera to the external device. However, methods other than the wakeup signal can be employed.

In step S404, it is determined whether a logical connection is established between the electronic camera and the external device. If it is determined that the logical connection is not established (NO in step S404), the process proceeds to step S405.

As described above, the transfer preparation is the state that the logical communication connection is established between the electronic camera and the external device, and the processing for transferring the data to the external device can be performed. That is, even if the electronic camera and the external device are physically connected with each other, a state that a communication is not substantially possible, is not included in the state of the transfer preparation. For example, in the case where the power for the communication is shut off for the power-saving, or the electronic camera and the external device are far apart, the communication with each other is not possible which is not included in the state of the transfer preparation.

In step S405, logical connections with other external devices are established. The above-described processing of steps S401 to S405 are performed to all external devices connected to the electronic camera.

The processing described in FIGS. 3 and 4 are performed in response to the shooting preparation of the SW1 62 which forms the release switch. Thus, in synchronization with the shooting preparation, the preparation for recording or the logical connection with an external device can be started. Accordingly, power consumption in a shooting standby state can be reduced.

Further, since the preparation for recording or the logical connection with an external device can be started before the SW2 is operated to perform an actual shooting processing, at the time of the shooting processing, data recording can be performed. That is, the delay in the data recording processing can be reduced as compared with the case where the communication is established after the shooting.

In the exemplary embodiment, in response to the shooting preparation, the recording preparation and the transfer preparation are performed. However, similar advantages can be obtained if the recording preparation and the transfer preparation are performed before the actual recording and transferring are performed. That is, the recording preparation and the transfer preparation can be performed at any timing if the logical connection with another external device is established in a period from the shooting preparation to the recording and the transfer.

### Other Exemplary Embodiments

While the present invention has been described with reference to the exemplary embodiment, it is to be understood that the invention is not limited to the disclosed exemplary embodiment. The scope of the following claims is to be accorded the broadest interpretation so as to encompass all modifications, equivalent structures, and functions.

In the exemplary embodiment as above described, it is assumed that the image file is transferred as the shot data to an external device. However, the shot data is not limited to the image file. Additional information attached to the image data such as a photographic condition, management information of the image data or information about an operation condition of the electronic camera can also be transferred as the shot data to the external device.

This application claims priority from Japanese Patent Application No. 2006-325667 filed on Dec. 1, 2006 which is hereby incorporated by reference herein in its entirety.

What is claimed:

1. An electronic camera which can transfer shot data to an external device, the electronic camera comprising:
an operation unit configured to instruct a shooting preparation operation or a shooting operation;
a connection unit configured to establish a logical connection with an external device; and
a control unit configured to perform control so that the connection unit establishes a logical connection with the external device when the shooting preparation operation or the shooting operation is started by the operation unit.

2. The electronic camera according to claim 1, further comprising:
a power control unit configured to control a start of power supply to an external device,
wherein the connection unit establishes a logical connection with the external device after the power control unit starts the power supply to the external device when the shooting preparation operation or the shooting operation is started by the operation unit.

3. The electronic camera according to claim 1, further comprising:
an instruction unit configured to instruct to restart power supply or to return from a power-saving mode to an external device when the shooting preparation operation or the shooting operation is started by the operation unit.

4. The electronic camera according to claim 1, wherein the control unit starts a shooting according to the operation input through the operation unit after a logical connection is established with an external device.

5. A method for controlling an electronic camera which can transfer shot data to an external device, the control method comprising:
instructing to perform a shooting preparation operation or a shooting operation; and
establishing a logical connection with an external device when the shooting preparation operation or the shooting operation is started according to the instruction.

6. The method according to claim 5, further comprising:
performing control to start power supply to the external device; and
establishing a logical connection with the external device after the power supply to the external device is started when the shooting preparation operation or the shooting operation is started.

7. The control method according to claim 5, further comprising, instructing to restart power supply or to return from a power-saving mode to an external device when the above shooting preparation operation or shooting operation is started.

8. The method according to claim 5, wherein a shooting according to the instruction is started after the logical connection is established with the external device.
